(19) United States
(12) Patent Application Publication
(10) Pub. No.: US 2021/0074446 A1
(43) Pub. Date: Mar. 11, 2021

(54) WIRING SYSTEM

(71) Applicants: AUTONETWORKS TECHNOLOGIES, LTD., Yokkaichi-shi, Mie-ken (JP); SUMITOMO WIRING SYSTEMS, LTD., Yokkaichi-shi, Mie-ken (JP); SUMITOMO ELECTRIC INDUSTRIES, LTD., Osaka-shi, Osaka (JP)

(72) Inventors: Naoya NISHIMURA, Yokkaichi-shi (JP); Taiji MOCHIZUKI, Yokkaichi-shi (JP)

(21) Appl. No.: 16/956,073

(22) PCT Filed: Nov. 16, 2018
(86) PCT No.: PCT/JP2018/042481

§ 371 Date: Jun. 19, 2020

(30) Foreign Application Priority Data
Dec. 26, 2017 (JP) 2017-248808

(51) Int. Cl. H01B 1/02; H01B 7/00; B60R 16/02

(52) U.S. Cl. CPC H01B 1/023; B60R 16/0207; H01B 1/026; H01B 7/0045

(57) ABSTRACT

The objective of the invention is to provide a wiring system by which it is possible to minimize size increases and reduced work efficiency during assembly even when using an aluminum wire or an aluminum alloy wire for at least a portion of a signal line. This wiring system includes a digital signal wire. This wiring system contains an aluminum wire or an aluminum alloy wire as the digital signal wire.

### TECHNICAL FIELD

The present invention relates to a wiring system of a vehicle and the like.

### BACKGROUND ART

Patent document 1 discloses a wire harness that supplies power from a battery to various types of devices and transmits signals between the devices. The wire harness includes two junction boxes, two controllers, a first power wire, a second power wire, a signal wire, and a trunk wire. The junction boxes are separated from each other and arranged at left and right sides of a vehicle. The controllers are arranged inside or outside the junction boxes to perform multiplex communication. The first power wire supplies power from the battery to the two junction boxes, and the second power wire supplies power from the two junction boxes to the devices. The signal wire transmits signals between the two controllers and the devices. The trunk wire is arranged between the two controllers and used by the controllers to perform multiplex communication. At least some of the first power wire, the second power wire, the signal wire, and the trunk wire are configured by a conductor including aluminum. As one mode of the wire harness, the patent document discloses an example where the electric wires configuring a group of power wires, which include the first power wire and the second power wire, are formed by a conductor that does not include aluminum, and the electric wires configuring a group of signal wires, which include the signal wire and the trunk wire, are formed by a conductor that includes aluminum.

### PRIOR ART DOCUMENT

### Patent Document

Patent Document 1: Japanese Laid-Open Patent Publication No. 2016-110811

### SUMMARY OF THE INVENTION

### Problems that the Invention is to Solve

It is expected that the types of devices in a vehicle such as sensors, electronic control units (ECUs), and the like will be increased to electrify parts and enable autonomous driving or the like. Further, in order to connect these devices, multiple networks will be constructed in the vehicle. This will lead to a dispersed arrangement of multiple gateways that connect the networks.

The increased types of devices and dispersed arrangement of a large number of gateways will increase the number of electric wires connecting gateways to one another, electric wires connecting the gateways and the devices, and electric wires connecting devices to one another. This will increase the weight of the vehicle and consequently lower fuel efficiency.

The electric wires can be replaced by aluminum wires or aluminum alloy wires to reduce the total weight of the electric wires used for wiring. As a solution, Patent Document 1 describes such a solution using a conductor including aluminum for the signal wires.

Signal wires are broadly categorized into analog circuits and digital circuits. When a conductor including aluminum is used in an analog circuit, the conductor including aluminum will be enlarged to match conductor resistance. This is because a conductor including aluminum has a higher conductor resistance than copper. Consequently, the weight-reducing advantage will be canceled and the fuel efficiency increasing advantage will be small. This also increases a ratio of the aluminum conductor included in one wire harness. Further, in general, aluminum has lower flexibility than copper. Thus, if a large portion of a wire harness is occupied by aluminum conductors, the flexibility of the entire harness will decrease and hinder layout operations when connecting or processing the harness. This will lower working efficiency.

Accordingly, an objective of the present invention is to provide a wiring system that limits decreases in working efficiency when connecting parts while avoiding enlargement even when at least some signal wires are aluminum wires or aluminum alloy wires.

### Means for Solving the Problems

In a first aspect, a wiring system includes a digital signal wire. The digital signal wire includes an aluminum wire or an aluminum alloy wire.

In a second aspect, the wiring system according to the first aspect is configured so that the digital signal wire includes an aluminum wire or an aluminum alloy wire having a resistance per unit length of 210 mΩ/m or less.

In a third aspect, the wiring system according to the first or second aspect is configured so that the digital signal wire includes an aluminum wire or an aluminum alloy wire having a resistance per unit length is 110 mΩ/m or greater.

In a fourth aspect, the wiring system according to any one of the first to third aspects is configured so that the wiring system includes a plurality of the digital signal wires. Each digital signal wire of the plurality of the digital signal wires is an aluminum wire or an aluminum alloy wire.

In a fifth aspect, the wiring system according to the fourth aspect is configured so that each digital signal wire of the plurality of the digital signal wires is an aluminum wire or an aluminum alloy wire having a resistance per unit length of 210 mΩ/m or less.

In a sixth aspect, the wiring system according to the fourth or fifth aspect is configured so that each digital signal wire of the plurality of the digital signal wires is an aluminum wire or an aluminum alloy wire having a resistance per unit length of 110 mΩ/m or greater.

In a seventh aspect, the wiring system according to any one of the first to sixth aspects is configured so that the aluminum wire or the aluminum alloy wire has a conductor cross-sectional area of 0.35 mm².

In an eighth aspect, the wiring system according to any one of the first to seventh aspects is configured so that the wiring system includes an analog signal wire. The analog signal wire includes a copper wire or a copper alloy wire.

### Effects of the Invention

With a digital signal, an operation voltage or a threshold voltage used to determine a signal can be set by a user in any manner. Unlike with an analog signal, this eliminates the need to match the conductor resistances. Thus, a configuration in which the digital signal wire includes an aluminum wire or an aluminum alloy wire as in the first aspect does not require increases in the size of the aluminum wire or the aluminum alloy wire to match with the conductor resistance of a copper wire or a copper alloy wire. This allows for use of, for example, an aluminum wire or an aluminum alloy wire having a diameter same as a copper wire or a copper alloy wire. Thus, even when at least some of the signal wires are aluminum wires or aluminum alloy wires, increases in size are limited and decreases in connecting efficiency are limited.

In accordance with the second aspect, the digital signal wire includes an aluminum wire or an aluminum alloy wire of 210 mΩ/m or less. This ensures resistance acceptable for transmission of digital signals.

In accordance with the third aspect, the digital signal wire includes an aluminum wire or an aluminum alloy wire having a resistance per unit length exceeding 110 mΩ/m. This further limits increases in size and maintains flexibility of the wire harness.

In accordance with the fourth aspect, even when at least some of the signal wires are aluminum wires or aluminum alloy wires, increases in size are limited and connecting efficiency is maintained more effectively.

In accordance with the fifth aspect, resistance acceptable for transmission of digital signals is ensured more effectively.

In accordance with the sixth aspect, increases in size of the wire harness are limited and flexibility of the wire harness is maintained more effectively.

In accordance with the seventh aspect, the electric wire having a conductor cross-sectional area of 0.35 mm² is used to limit increases in size and maintain flexibility of the wire harness.

With an analog signal, use of an aluminum wire or an aluminum alloy wire requires increases the size and lowers the flexibility to match conductor resistance. Accordingly, a configuration in which the analog signal wire includes a copper wire or a copper alloy wire as in the eighth aspect, limits increases in size of the analog signal wire and maintains the connecting efficiency. In this case, the digital signal wire includes an aluminum wire or an aluminum alloy wire while limiting increases in size of the entire wiring system and maintaining the connecting efficiency.

### BRIEF DESCRIPTION OF THE DRAWINGS

FIG. 1 is a schematic diagram showing a wiring system of one embodiment.

FIG. 2 is a cross-sectional view of an electric wire.

FIG. 3 is a diagram illustrating a relationship between a conductor cross-sectional area and a conductor resistance.

FIG. 4 is a schematic diagram showing a wiring system of a modified example.

### MODES FOR CARRYING OUT THE INVENTION

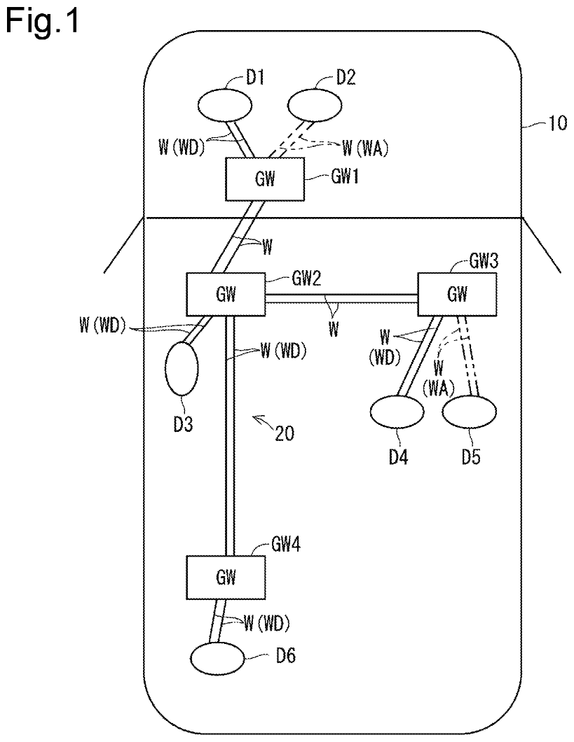

A wiring system of a first embodiment will now be described. FIG. 1 is a schematic diagram showing a wiring system 20 of a vehicle 10.

The vehicle 10 includes electric devices. Examples of the electric devices may include gateways GW1 to GW4, various types of devices D1 to D6, and the like.

The gateways GW1 to GW4 are communication relay devices that connect networks. The gateways GW1 to GW4 may be dispersedly arranged in the vehicle 10.

An electronic control unit (ECU) may be incorporated in or connected to one or more of the gateways GW1 to GW4. The ECU controls each device of the vehicle 10 by receiving a signal from any one of the devices D1 to D6 or sending a control signal to any one of the devices D1 to D6.

The devices D1 to D6 are sensors that detect the conditions of parts of the vehicle 10 such as motors, which drive parts of the vehicle 10, lights, and the like.

The wiring system 20 electrically connects various electric devices installed in the vehicle 10 such as the gateways GW1 to GW4 and devices D1 to D6. The wiring system 20 includes wires W, which connect the gateways GW1 to GW4, and wires W, which connect the gateways GW1 to GW4 and the devices D1 to D6.

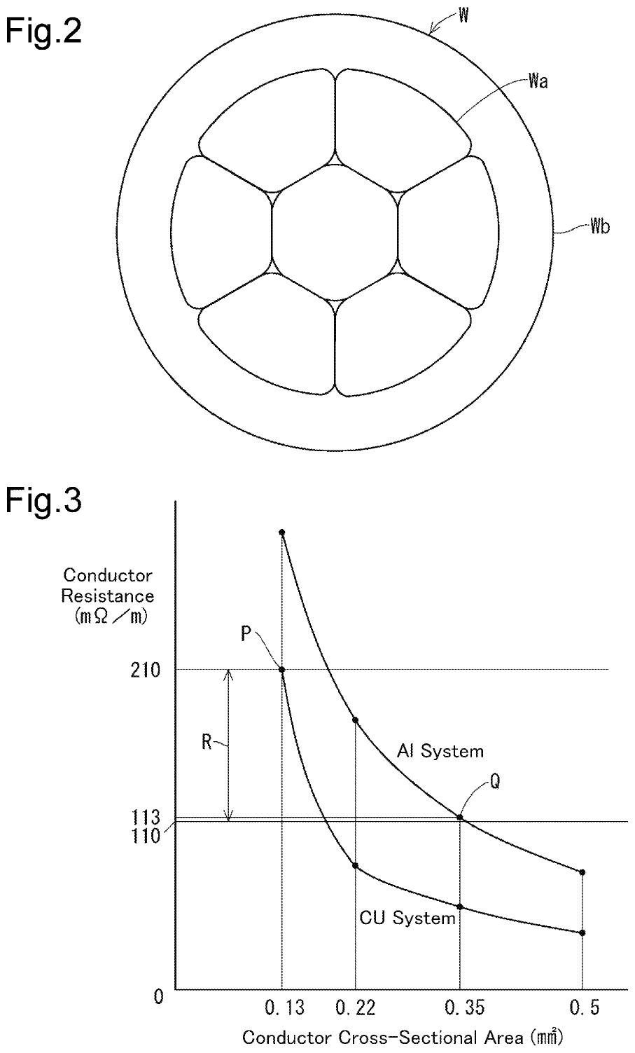

Each wire W, as shown in FIG. 2, includes a core wire Wa and a sheath Wb that surrounds and covers the core wire Wa.

The core wire Wa is a linear member made of aluminum, an aluminum alloy having a main component of aluminum, copper, or a copper alloy having a main component of copper. A wire W that includes a core wire Wa of aluminum is referred to as an aluminum wire, and a wire W that includes a core wire Wa of aluminum alloy is referred to as an aluminum alloy wire. A wire W that includes a core wire Wa of copper is referred to as a copper wire, and a wire W that includes a core wire Wa of copper alloy is referred to as a copper alloy wire. The core wire Wa may be a stranded wire, in which multiple strands are twisted, or a single strand. When the core wire Wa is a stranded wire, the strands may be compressed but do not have to be compressed. In FIG. 2, the core wire Wa is a compressed stranded wire, in which the strands are twisted and compressed.

The sheath Wb is formed, for example, by coating the core wire Wa with heated and softened resin by performing extrusion.

The wiring system 20 may be configured by a wire harness that physically gathers the wires W by, for example, connecting the wires W with a connector, bundling the wires W with a cable tie, an adhesive tape, or the like. The wiring system 20 may be configured by one wire harness or more than one wire harness.

A power wire for supplying electric power may be arranged in the wiring system 20. The power wire may be bundled together with the wires W or separated from the wires W.

The wiring system 20 includes a digital signal wire WD. The digital signal wire WD serves as a transmission medium that transmits digital signals between the gateways GW1 to GW4 or between any of the gateways GW1 to GW4 and any of the devices D1 to D6. The standard of the digital signals is not particularly limited but may be Controller Area Network (CAN), Ethernet (registered trademark), Local Interconnect Network (LIN), Clock Extension Peripheral Interface (CXIP), or the like.

The wiring system 20 includes one or more digital signal wires WD, the number of which corresponds to the number of the gateways GW1 to GW4 or the like and the devices D1 to D6. In the present embodiment, the wiring system 20 includes more than one digital signal wire WD.

The digital signal wire WD includes an aluminum wire or an aluminum alloy wire. When there is more than one digital signal wire WD, some or all of the digital signal wires WD are aluminum wires or aluminum alloy wires.

A configuration in which the digital signal wires WD include aluminum wires or aluminum alloy wires has the following benefits.

With a digital signal, an operation voltage or a threshold voltage used to determine a signal can be set by a user in any manner. Thus, even when conventional copper wires or copper alloy wires are replaced with aluminum wires or aluminum alloy wires, there will be no need to match the conductor resistance with the conventional copper wires or copper alloy wires. Accordingly, the aluminum wires or the aluminum alloy wires do not have to be greatly increased in size (conductor cross-sectional area) to match the conductor resistance of the copper wires or copper alloy wires. This allows, for example, use of aluminum wires or aluminum alloy wires having the same or slightly greater size than conventionally used coppers wire or copper alloy wires. Thus, even when aluminum wires or aluminum alloy wires are used as at least some of the signal wires, enlargement is limited, and decreases in the connecting efficiency are limited. Also, the use of aluminum wires or aluminum alloy wires as the digital signal wires WD reduces weight. The reduction in weight of the wiring system 20 increases fuel efficiency.

The above benefits can be obtained to a certain extent even when some of the digital signal wires WD are aluminum wires or aluminum alloy wires. The above benefits can be obtained to a greater extent when all of the digital signal wires WD are aluminum wires or aluminum alloy wires.

Further, the wiring system 20 includes one or more analog signal wires WA. In the present embodiment, the wiring system 20 includes more than one analog signal wires WA.

The analog signal wires WA may include copper wires or copper alloy wires.

With an analog signal, when a resistance of a transmission line changes, the output voltage will also change. In order to allow for detection of the output voltage that corresponds to the input voltage, a wiring system is set taking into consideration that the transmission line has a predetermined resistance. Thus, when a conventionally used copper wire or copper alloy wire is replaced with an aluminum wire or an aluminum alloy wire, there will be a need to match the conductor resistance of the aluminum wire or the aluminum alloy wire with that of the conventionally used copper wire or copper alloy wire. When the size is the same, a copper wire or a copper alloy wire has a greater resistance than an aluminum wire or an aluminum alloy wire. Thus, when matching resistance, an aluminum wire or an aluminum alloy wire will need to be greatly increased in size from the conventionally used copper wire or copper alloy wire. Further, the increase in size will lower flexibility and connecting efficiency of the wire harness. Accordingly, in comparison with when replacing the digital signal wires WD with aluminum wires or aluminum alloy wires, the benefit is small when replacing the analog signal wires WA with aluminum wires or aluminum alloy wires.

Therefore, the analog signal wires WA may include copper wires or copper alloy wires. In a case where there is more than one analog signal wire WA, some of the analog signal wires WA may be copper wires or copper alloy wires, and the rest of the analog signal wires WA may be aluminum wires or aluminum alloy wires. Alternatively, all of the analog signal wires WA may be copper wires or copper alloy wires.

Rather, when the analog signal wires WA include copper wires or copper alloy wires, increases in the size of the analog signal wires are limited and the connecting efficiency is not lowered.

Even in this case, since the digital signal wires WD include aluminum wires or aluminum alloy wires, increases in size of the entire wiring system 20 are limited and the connecting efficiency is maintained in the same manner as described above.

FIG. 3 illustrates the relationship of the conductor cross-sectional area and the conductor resistance for each of an aluminum wire or an aluminum alloy wire and a copper wire or a copper alloy wire. In FIG. 3, the above-described relationship in an aluminum wire or an aluminum alloy wire is indicated by an Al system curve, and the above-described relationship in a copper wire or a copper alloy wire is indicated by a Cu system curve.

The resistance per unit length of an aluminum wire or an aluminum alloy wire used as the digital signal wire WD may be 210 mΩ/m or less.

When an aluminum wire or an aluminum alloy wire has a resistance per unit length of 210 mΩ/m or less, resistance acceptable for transmission of a digital signal is ensured.

Further, an aluminum wire or an aluminum alloy wire used as the digital signal wire WD may have a resistance per unit length of 110 mΩ/m or greater.

When an aluminum wire or an aluminum alloy wire has a resistance per unit length of 110 mΩ/m or greater, this will mean that the aluminum wire or aluminum alloy wire has a size that is less than or equal to a predetermined dimension. Thus, increases in size are limited, and decreases in flexibility are limited.

Technical concepts will further be clarified in comparison with a copper wire or a copper alloy wire.

In JASO D611, Japanese Automotive Standards Organization sets the conductor cross section of a copper wire or a copper alloy wire to 0.13 mm², 0.22 mm², 0.35 mm², 0.5 mm² . . . in ascending order. When this is applied to an aluminum wire or an aluminum alloy wire and taking into consideration the relationship of specific resistance between copper or copper alloy and aluminum or aluminum alloy, the resistance per unit length of an aluminum wire or an aluminum alloy wire having a conductor cross-sectional area of 0.13 mm² is approximately 300 mΩ/m, the resistance per unit length of an aluminum wire or an aluminum alloy wire having a conductor cross-sectional area of 0.22 mm² is 176 mΩ/m, the resistance per unit length of an aluminum wire or an aluminum alloy wire having a conductor cross-sectional area of 0.35 mm² is approximately 113 mΩ/m, and the resistance per unit length of an aluminum wire or an aluminum alloy wire having a conductor cross-sectional area of 0.5 mm² is approximately 77 mΩ/m.

Based on these results, the conductor resistance is too large in an aluminum wire or an aluminum alloy wire having a conductor cross-sectional area of 0.13 mm², and the voltage drop will be too large when the wire is used as the digital signal wire WD. Accordingly, the digital signal wire WD using this wire will not have the capability required for transmission of a digital signal. A copper alloy wire having a conductor cross-sectional area of 0.13 mm² has been used as the digital signal wire WD. The conductor resistance of a copper alloy wire having a conductor cross-sectional area of 0.13 mm² is 210 mΩ/m (refer to point P in FIG. 3). Thus, if an aluminum wire or an aluminum alloy wire were to have a resistance per unit length of 210 mΩ/m or less, large voltage drops would be limited, and the resistance would be acceptable for transmission of a digital signal.

Further, when an aluminum wire or an aluminum alloy wire has a conductor cross-sectional area of 0.5 mm², the weight reducing effect is decreased and the size is increased. Further, flexibility is decreased, and connecting efficiency is decreased. The conductor resistance of an aluminum wire or an aluminum alloy wire having a conductor cross-sectional area of 0.5 mm² is 77 mΩ/m. Thus, when using an aluminum wire or an aluminum alloy wire having a conductor resistance exceeding 77 mΩ/m, increases in size are limited, and decreases in connecting efficiency are limited.

An aluminum wire or an aluminum alloy wire having a conductor cross-sectional area of 0.35 mm², which is a size that is one level smaller than 0.5 mm², has a conductor resistance of 113 mΩ/m (refer to point Q in FIG. 3). Thus, an aluminum wire or an aluminum alloy wire having a resistance per unit length of 110 mΩ/m should be used in practice.

Accordingly, an aluminum wire or an aluminum alloy wire having a resistance per unit length of 110 mΩ/m or greater and 210 mΩ/m or less, which is indicated by range R in FIG. 3, may be used as the digital signal wire WD. Further, an aluminum wire or an aluminum alloy wire having a conductor cross-sectional area of 0.35 mm² may be used as the digital signal wire WD. An aluminum wire or an aluminum alloy wire having a conductor cross-sectional area of 0.35 mm² includes a wire having a conductor cross-sectional area within a range of manufacturing error from 0.35 mm².

With the wiring system 20, the digital signal wires WD include aluminum wires or aluminum alloy wires. This limits increases in size and limits decreases in connecting efficiency even when at least some of the signal wires use aluminum wires or aluminum alloy wires.

Further, the digital signal wires WD including aluminum wires or aluminum alloy wires that have a resistance per unit length of 210 mΩ/m or less ensure resistance acceptable for the transmission of digital signals.

Also, the digital signal wires WD including aluminum wires or aluminum alloy wires that have a resistance per unit length of 110 mΩ/m or greater further limit increases in size and limit decreases in flexibility.

Moreover, when all of the digital signal wires WD are aluminum wires or aluminum alloy wires, increases in size are more effectively limited and decreases in connecting efficiency are limited even when some of the signal wires use aluminum wires or aluminum alloy wires.

Furthermore, when all of the digital signal wires WD are aluminum wires or aluminum alloy wires having a resistance per unit length of 210 mΩ/m or less, resistance acceptable for the transmission of digital signals is more effectively ensured.

Additionally, when all of the digital signal wires WD are aluminum wires or aluminum alloy wires having a resistance per unit length of 110 mΩ/m or greater, increases in size and decreases in flexibility are more effectively limited.

Further, as long as an aluminum wire or an aluminum alloy wire is an electric wire having a conductor cross-sectional area of 0.35 mm² the use of the aluminum wire or aluminum alloy wire having a conductor cross-sectional area of 0.35 mm², which is the size of a copper wire or a copper alloy wire, limits increases in size and limits decreases in flexibility.

When the wiring system 20 includes the analog signal wires W and if the analog signal wires WA includes copper wires or copper alloy wires, the analog signal wire WA will also limit increases in size and limit decreases in the connecting efficiency. In this case, the digital signal wires WD include aluminum wires or aluminum alloy wires. This limits increases in the size of the wiring system 20 and limits decreases in the connecting efficiency.

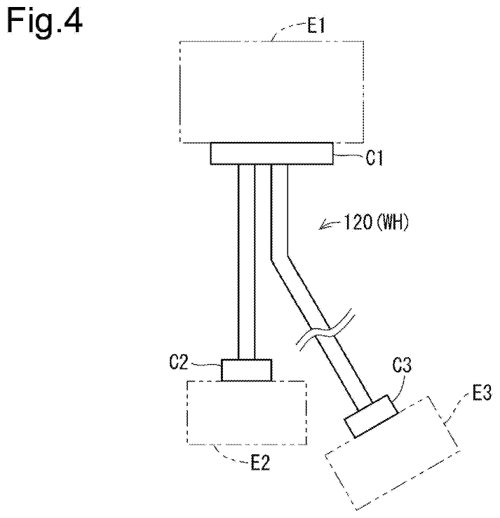

FIG. 4 shows a modified example in which a wiring system 120 is configured by a single wire harness WH. As shown in FIG. 4, one electric device E1 is connected to other electric devices E2 and E3 by the single wire harness WH. The electric device E1 and the electric device E2 are connected by the wire W, and the electric device E1 and the electric device E3 are connected by the wire W. The wire W connecting the electric device E1 and the electric device E2 corresponds to the digital signal wire WD, and the wire W connecting the electric device E1 and the electric device E3 corresponds to the analog signal wire WA. The digital signal wire WD and the analog signal wire WA are inserted and connected to a connector Cl at a side of the electric device E1. The connector Cl bundles the digital signal wire WD and the analog signal wire WA into one wire harness.

The digital signal wire WD uses an aluminum wire or an aluminum alloy wire.

The analog signal wire WA may use a copper wire or a copper alloy wire.

The aluminum wire or the aluminum alloy wire used as the digital signal wire WD limits increases in size and limits decreases in connecting efficiency.

### MODIFIED EXAMPLE

The structures described in the above embodiment and modified example can be combined as long as they are technically consistent with each other.

The above description of the present invention is illustrative and the invention is not to be limited to the details given herein. It should be apparent to those skilled in the art that the present invention may be embodied in many other specific forms without departing from the spirit or scope of the invention.

### DESCRIPTION OF THE REFERENCE NUMERALS

20, 120 wiring system
D1 to D6 devices
E1 to E3 electric devices
GW1 to GW4 gateways
W wire
WA analog signal wire
WD digital signal wire
WH wire harness

### BACKGROUND

### Field of the Disclosure

The present disclosure relates to a wiring system of a vehicle and the like.

### Related Art

Japanese Laid-Open Patent Publication No. 2016-110811 discloses a wire harness that supplies power from a battery to various types of devices and transmits signals between the devices. The wire harness includes two junction boxes, two controllers, a first power wire, a second power wire, a signal wire, and a trunk wire. The junction boxes are separated from each other and arranged at left and right sides of a vehicle. The controllers are arranged inside or outside the junction boxes to perform multiplex communication. The first power wire supplies power from the battery to the two junction boxes, and the second power wire supplies power from the two junction boxes to the devices. The signal wire transmits signals between the two controllers and the devices. The trunk wire is arranged between the two controllers and used by the controllers to perform multiplex communication. At least some of the first power wire, the second power wire, the signal wire, and the trunk wire are configured by a conductor including aluminum. As one mode of the wire harness, the patent document discloses an example where the electric wires configuring a group of power wires, which include the first power wire and the second power wire, are formed by a conductor that does not include aluminum, and the electric wires configuring a group of signal wires, which include the signal wire and the trunk wire, are formed by a conductor that includes aluminum.

It is expected that the types of devices in a vehicle such as sensors, electronic control units (ECUs), and the like will be increased to electrify parts and enable autonomous driving or the like. Further, in order to connect these devices, multiple networks will be constructed in the vehicle. This will lead to a dispersed arrangement of multiple gateways that connect the networks.

The increased types of devices and dispersed arrangement of a large number of gateways will increase the number of electric wires connecting gateways to one another, electric wires connecting the gateways and the devices, and electric wires connecting devices to one another. This will increase the weight of the vehicle and consequently lower fuel efficiency.

The electric wires can be replaced by aluminum wires or aluminum alloy wires to reduce the total weight of the electric wires used for wiring. As a solution, Patent Document 1 describes such a solution using a conductor including aluminum for the signal wires.

Signal wires are broadly categorized into analog circuits and digital circuits. When a conductor including aluminum is used in an analog circuit, the conductor including aluminum will be enlarged to match conductor resistance. This is because a conductor including aluminum has a higher conductor resistance than copper. Consequently, the weight-reducing advantage will be canceled and the fuel efficiency increasing advantage will be small. This also increases a ratio of the aluminum conductor included in one wire harness. Further, in general, aluminum has lower flexibility than copper. Thus, if a large portion of a wire harness is occupied by aluminum conductors, the flexibility of the entire harness will decrease and hinder layout operations when connecting or processing the harness. This will lower working efficiency.

Accordingly, an objective of the present disclosure is to provide a wiring system that limits decreases in working efficiency when connecting parts while avoiding enlargement even when at least some signal wires are aluminum wires or aluminum alloy wires.

### SUMMARY

In a first aspect, a wiring system includes a digital signal wire. The digital signal wire includes an aluminum wire or an aluminum alloy wire.

In a second aspect, the wiring system according to the first aspect is configured so that the digital signal wire includes an aluminum wire or an aluminum alloy wire having a resistance per unit length of 210 mΩ/m or less.

In a third aspect, the wiring system according to the first or second aspect is configured so that the digital signal wire includes an aluminum wire or an aluminum alloy wire having a resistance per unit length is 110 mΩ/m or greater.

In a fourth aspect, the wiring system according to any one of the first to third aspects is configured so that the wiring system includes a plurality of the digital signal wires. Each digital signal wire of the plurality of the digital signal wires is an aluminum wire or an aluminum alloy wire.

In a fifth aspect, the wiring system according to the fourth aspect is configured so that each digital signal wire of the plurality of the digital signal wires is an aluminum wire or an aluminum alloy wire having a resistance per unit length of 210 mΩ/m or less.

In a sixth aspect, the wiring system according to the fourth or fifth aspect is configured so that each digital signal wire of the plurality of the digital signal wires is an aluminum wire or an aluminum alloy wire having a resistance per unit length of 110 mΩ/m or greater.

In a seventh aspect, the wiring system according to any one of the first to sixth aspects is configured so that the aluminum wire or the aluminum alloy wire has a conductor cross-sectional area of 0.35 mm².

In an eighth aspect, the wiring system according to any one of the first to seventh aspects is configured so that the wiring system includes an analog signal wire. The analog signal wire includes a copper wire or a copper alloy wire.

With a digital signal, an operation voltage or a threshold voltage used to determine a signal can be set by a user in any manner. Unlike with an analog signal, this eliminates the need to match the conductor resistances. Thus, a configuration in which the digital signal wire includes an aluminum wire or an aluminum alloy wire as in the first aspect does not require increases in the size of the aluminum wire or the aluminum alloy wire to match with the conductor resistance of a copper wire or a copper alloy wire. This allows for use of, for example, an aluminum wire or an aluminum alloy wire having a diameter same as a copper wire or a copper alloy wire. Thus, even when at least some of the signal wires are aluminum wires or aluminum alloy wires, increases in size are limited and decreases in connecting efficiency are limited.

In accordance with the second aspect, the digital signal wire includes an aluminum wire or an aluminum alloy wire having a resistance per unit length of 210 mΩ/m or less. This ensures resistance acceptable for transmission of digital signals.

In accordance with the third aspect, the digital signal wire includes an aluminum wire or an aluminum alloy wire having a resistance per unit length exceeding 110 mΩ/m. This further limits increases in size and maintains flexibility of the wire harness.

In accordance with the fourth aspect, even when at least some of the signal wires are aluminum wires or aluminum alloy wires, increases in size are limited and connecting efficiency is maintained more effectively.

In accordance with the fifth aspect, resistance acceptable for transmission of digital signals is ensured more effectively.

In accordance with the sixth aspect, increases in size of the wire harness are limited and flexibility of the wire harness is maintained more effectively.

In accordance with the seventh aspect, the electric wire having a conductor cross-sectional area of 0.35 mm² is used to limit increases in size and maintain flexibility of the wire harness.

With an analog signal, use of an aluminum wire or an aluminum alloy wire requires increases the size and lowers the flexibility to match conductor resistance. Accordingly, a configuration in which the analog signal wire includes a copper wire or a copper alloy wire as in the eighth aspect, limits increases in size of the analog signal wire and maintains the connecting efficiency. In this case, the digital signal wire includes an aluminum wire or an aluminum alloy wire while limiting increases in size of the entire wiring system and maintaining the connecting efficiency.

### BRIEF DESCRIPTION OF THE DRAWINGS

FIG. 1 is a schematic diagram showing a wiring system of one embodiment.

FIG. 2 is a cross-sectional view of an electric wire.

FIG. 3 is a diagram illustrating a relationship between a conductor cross-sectional area and a conductor resistance.

FIG. 4 is a schematic diagram showing a wiring system of a modified example.

### DETAILED DESCRIPTION

A wiring system of a first embodiment will now be described. FIG. 1 is a schematic diagram showing a wiring system 20 of a vehicle 10.

The vehicle 10 includes electric devices. Examples of the electric devices may include gateways GW1 to GW4, various types of devices D1 to D6, and the like.

The gateways GW1 to GW4 are communication relay devices that connect networks. The gateways GW1 to GW4 may be dispersedly arranged in the vehicle 10.

An electronic control unit (ECU) may be incorporated in or connected to one or more of the gateways GW1 to GW4. The ECU controls each device of the vehicle 10 by receiving a signal from any one of the devices D1 to D6 or sending a control signal to any one of the devices D1 to D6.

The devices D1 to D6 are sensors that detect the conditions of parts of the vehicle 10 such as motors, which drive parts of the vehicle 10, lights, and the like.

The wiring system 20 electrically connects various electric devices installed in the vehicle 10 such as the gateways GW1 to GW4 and devices D1 to D6. The wiring system 20 includes wires W, which connect the gateways GW1 to GW4, and wires W, which connect the gateways GW1 to GW4 and the devices D1 to D6.

Each wire W, as shown in FIG. 2, includes a core wire Wa and a sheath Wb that surrounds and covers the core wire Wa.

The core wire Wa is a linear member made of aluminum, an aluminum alloy having a main component of aluminum, copper, or a copper alloy having a main component of copper. A wire W that includes a core wire Wa of aluminum is referred to as an aluminum wire, and a wire W that includes a core wire Wa of aluminum alloy is referred to as an aluminum alloy wire. A wire W that includes a core wire Wa of copper is referred to as a copper wire, and a wire W that includes a core wire Wa of copper alloy is referred to as a copper alloy wire. The core wire Wa may be a stranded wire, in which multiple strands are twisted, or a single strand. When the core wire Wa is a stranded wire, the strands may be compressed but do not have to be compressed. In FIG. 2, the core wire Wa is a compressed stranded wire, in which the strands are twisted and compressed.

The sheath Wb is formed, for example, by coating the core wire Wa with heated and softened resin by performing extrusion.

The wiring system 20 may be configured by a wire harness that physically gathers the wires W by, for example, connecting the wires W with a connector, bundling the wires W with a cable tie, an adhesive tape, or the like. The wiring system 20 may be configured by one wire harness or more than one wire harness.

A power wire for supplying electric power may be arranged in the wiring system 20. The power wire may be bundled together with the wires W or separated from the wires W.

The wiring system 20 includes a digital signal wire WD. The digital signal wire WD serves as a transmission medium that transmits digital signals between the gateways GW1 to GW4 or between any of the gateways GW1 to GW4 and any of the devices D1 to D6. The standard of the digital signals is not particularly limited but may be Controller Area Network (CAN), Ethernet (registered trademark), Local Interconnect Network (LIN), Clock Extension Peripheral Interface (CXPI), or the like.

The wiring system 20 includes one or more digital signal wires WD, the number of which corresponds to the number of the gateways GW1 to GW4 or the like and the devices D1 to D6. In the present embodiment, the wiring system 20 includes more than one digital signal wire WD.

The digital signal wire WD includes an aluminum wire or an aluminum alloy wire. When there is more than one digital signal wire WD, some or all of the digital signal wires WD are aluminum wires or aluminum alloy wires.

A configuration in which the digital signal wires WD include aluminum wires or aluminum alloy wires has the following benefits.

With a digital signal, an operation voltage or a threshold voltage used to determine a signal can be set by a user in any manner. Thus, even when conventional copper wires or copper alloy wires are replaced with aluminum wires or aluminum alloy wires, there will be no need to match the conductor resistance with the conventional copper wires or copper alloy wires. Accordingly, the aluminum wires or the aluminum alloy wires do not have to be greatly increased in size (conductor cross-sectional area) to match the conductor resistance of the copper wires or copper alloy wires. This allows, for example, use of aluminum wires or aluminum alloy wires having the same or slightly greater size than conventionally used coppers wire or copper alloy wires. Thus, even when aluminum wires or aluminum alloy wires are used as at least some of the signal wires, enlargement is limited, and decreases in the connecting efficiency are limited. Also, the use of aluminum wires or aluminum alloy wires as the digital signal wires WD reduces weight. The reduction in weight of the wiring system 20 increases fuel efficiency.

The above benefits can be obtained to a certain extent even when some of the digital signal wires WD are aluminum wires or aluminum alloy wires. The above benefits can be obtained to a greater extent when all of the digital signal wires WD are aluminum wires or aluminum alloy wires.

Further, the wiring system 20 includes one or more analog signal wires WA. In the present embodiment, the wiring system 20 includes more than one analog signal wires WA.

The analog signal wires WA may include copper wires or copper alloy wires.

With an analog signal, when a resistance of a transmission line changes, the output voltage will also change. In order to allow for detection of the output voltage that corresponds to the input voltage, a wiring system is set taking into consideration that the transmission line has a predetermined resistance. Thus, when a conventionally used copper wire or copper alloy wire is replaced with an aluminum wire or an aluminum alloy wire, there will be a need to match the conductor resistance of the aluminum wire or the aluminum alloy wire with that of the conventionally used copper wire or copper alloy wire. When the size is the same, an aluminum wire or an aluminum alloy wire has a greater resistance than a copper wire or a copper alloy wire. Thus, when matching resistance, an aluminum wire or an aluminum alloy wire will need to be greatly increased in size from the conventionally used copper wire or copper alloy wire. Further, the increase in size will lower flexibility and connecting efficiency of the wire harness. Accordingly, in comparison with when replacing the digital signal wires WD with aluminum wires or aluminum alloy wires, the benefit is small when replacing the analog signal wires WA with aluminum wires or aluminum alloy wires.

Therefore, the analog signal wires WA may include copper wires or copper alloy wires. In a case where there is more than one analog signal wire WA, some of the analog signal wires WA may be copper wires or copper alloy wires, and the rest of the analog signal wires WA may be aluminum wires or aluminum alloy wires. Alternatively, all of the analog signal wires WA may be copper wires or copper alloy wires.

Rather, when the analog signal wires WA include copper wires or copper alloy wires, increases in the size of the analog signal wires are limited and the connecting efficiency is not lowered.

Even in this case, since the digital signal wires WD include aluminum wires or aluminum alloy wires, increases in size of the entire wiring system 20 are limited and the connecting efficiency is maintained in the same manner as described above.

FIG. 3 illustrates the relationship of the conductor cross-sectional area and the conductor resistance for each of an aluminum wire or an aluminum alloy wire and a copper wire or a copper alloy wire. In FIG. 3, the above-described relationship in an aluminum wire or an aluminum alloy wire is indicated by an Al system curve, and the above-described relationship in a copper wire or a copper alloy wire is indicated by a Cu system curve.

The resistance per unit length of an aluminum wire or an aluminum alloy wire used as the digital signal wire WD may be 210 mΩ/m or less.

When an aluminum wire or an aluminum alloy wire has a resistance per unit length of 210 mΩ/m or less, resistance acceptable for transmission of a digital signal is ensured.

Further, an aluminum wire or an aluminum alloy wire used as the digital signal wire WD may have a resistance per unit length of 110 mΩ/m or greater.

When an aluminum wire or an aluminum alloy wire has a resistance per unit length of 110 mΩ/m or greater, this will mean that the aluminum wire or aluminum alloy wire has a size that is less than or equal to a predetermined dimension. Thus, increases in size are limited, and decreases in flexibility are limited.

Technical concepts will further be clarified in comparison with a copper wire or a copper alloy wire.

In JASO D611, Japanese Automotive Standards Organization sets the conductor cross section of a copper wire or a copper alloy wire to 0.13 mm², 0.22 mm², 0.35 mm², 0.5 mm² . . . in ascending order. When this is applied to an aluminum wire or an aluminum alloy wire and taking into consideration the relationship of specific resistance between copper or copper alloy and aluminum or aluminum alloy, the resistance per unit length of an aluminum wire or an aluminum alloy wire having a conductor cross-sectional area of 0.13 mm² is approximately 300 mΩ/m, the resistance per unit length of an aluminum wire or an aluminum alloy wire having a conductor cross-sectional area of 0.22 mm² is 176 mΩ/m, the resistance per unit length of an aluminum wire or an aluminum alloy wire having a conductor cross-sectional area of 0.35 mm² is approximately 113 mΩ/m, and the resistance per unit length of an aluminum wire or an aluminum alloy wire having a conductor cross-sectional area of 0.5 mm² is approximately 77 mΩ/m.

Based on these results, the conductor resistance is too large in an aluminum wire or an aluminum alloy wire having a conductor cross-sectional area of 0.13 mm², and the voltage drop will be too large when the wire is used as the digital signal wire WD. Accordingly, the digital signal wire WD using this wire will not have the capability required for transmission of a digital signal. A copper alloy wire having a conductor cross-sectional area of 0.13 mm² has been used as the digital signal wire WD. The conductor resistance of a copper alloy wire having a conductor cross-sectional area of 0.13 mm² is 210 mΩ/m (refer to point P in FIG. 3). Thus, if an aluminum wire or an aluminum alloy wire were to have a resistance per unit length of 210 mΩ/m or less, large voltage drops would be limited, and the resistance would be acceptable for transmission of a digital signal.

Further, when an aluminum wire or an aluminum alloy wire has a conductor cross-sectional area of 0.5 mm², the weight reducing effect is decreased and the size is increased. Further, flexibility is decreased, and connecting efficiency is decreased. The conductor resistance of an aluminum wire or an aluminum alloy wire having a conductor cross-sectional area of 0.5 mm² is 77 mΩ/m. Thus, when using an aluminum wire or an aluminum alloy wire having a conductor resistance exceeding 77 mΩ/m, increases in size are limited, and decreases in connecting efficiency are limited.

An aluminum wire or an aluminum alloy wire having a conductor cross-sectional area of 0.35 mm², which is a size that is one level smaller than 0.5 mm², has a conductor resistance of 113 mΩ/m (refer to point Q in FIG. 3). Thus, an aluminum wire or an aluminum alloy wire having a resistance per unit length of 110 mΩ/m should be used in practice.

Accordingly, an aluminum wire or an aluminum alloy wire having a resistance per unit length of 110 mΩ/m or greater and 210 mΩ/m or less, which is indicated by range R in FIG. 3, may be used as the digital signal wire WD. Further, an aluminum wire or an aluminum alloy wire having a conductor cross-sectional area of 0.35 mm² may be used as the digital signal wire WD. An aluminum wire or an aluminum alloy wire having a conductor cross-sectional area of 0.35 mm² includes a wire having a conductor cross-sectional area within a range of manufacturing error from 0.35 mm².

With the wiring system 20, the digital signal wires WD include aluminum wires or aluminum alloy wires. This limits increases in size and limits decreases in connecting efficiency even when at least some of the signal wires use aluminum wires or aluminum alloy wires.

Further, the digital signal wires WD including aluminum wires or aluminum alloy wires that have a resistance per unit length of 210 mΩ/m or less ensure resistance acceptable for the transmission of digital signals.

Also, the digital signal wires WD including aluminum wires or aluminum alloy wires that have a resistance per unit length of 110 mΩ/m or greater further limit increases in size and limit decreases in flexibility.

Moreover, when all of the digital signal wires WD are aluminum wires or aluminum alloy wires, increases in size are more effectively limited and decreases in connecting efficiency are limited even when some of the signal wires use aluminum wires or aluminum alloy wires.

Furthermore, when all of the digital signal wires WD are aluminum wires or aluminum alloy wires having a resistance per unit length of 210 mΩ/m or less, resistance acceptable for the transmission of digital signals is more effectively ensured.

Additionally, when all of the digital signal wires WD are aluminum wires or aluminum alloy wires having a resistance per unit length of 110 mΩ/m or greater, increases in size and decreases in flexibility are more effectively limited.

Further, as long as an aluminum wire or an aluminum alloy wire is an electric wire having a conductor cross-sectional area of 0.35 mm² the use of the aluminum wire or aluminum alloy wire having a conductor cross-sectional area of 0.35 mm², which is the size of a copper wire or a copper alloy wire, limits increases in size and limits decreases in flexibility.

When the wiring system 20 includes the analog signal wires W and if the analog signal wires WA includes copper wires or copper alloy wires, the analog signal wire WA will also limit increases in size and limit decreases in the connecting efficiency. In this case, the digital signal wires WD include aluminum wires or aluminum alloy wires. This limits increases in the size of the wiring system 20 and limits decreases in the connecting efficiency.

FIG. 4 shows a modified example in which a wiring system 120 is configured by a single wire harness WH. As shown in FIG. 4, one electric device E1 is connected to other electric devices E2 and E3 by the single wire harness WH. The electric device E1 and the electric device E2 are connected by the wire W, and the electric device E1 and the electric device E3 are connected by the wire W. The wire W connecting the electric device E1 and the electric device E2 corresponds to the digital signal wire WD, and the wire W connecting the electric device E1 and the electric device E3 corresponds to the analog signal wire WA. The digital signal wire WD and the analog signal wire WA are inserted and connected to a connector Cl at a side of the electric device E1. The connector Cl bundles the digital signal wire WD and the analog signal wire WA into one wire harness.

The digital signal wire WD uses an aluminum wire or an aluminum alloy wire.

The analog signal wire WA may use a copper wire or a copper alloy wire.

The aluminum wire or the aluminum alloy wire used as the digital signal wire WD limits increases in size and limits decreases in connecting efficiency.

### MODIFIED EXAMPLE

The structures described in the above embodiment and modified example can be combined as long as they are technically consistent with each other.

The above description of the present disclosure is illustrative and the invention is not to be limited to the details given herein. It should be apparent to those skilled in the art that the present disclosure may be embodied in many other specific forms without departing from the spirit or scope of the invention.

### DESCRIPTION OF THE REFERENCE NUMERALS

20, 120 wiring system
D1 to D6 devices
E1 to E3 electric devices
GW1 to GW4 gateways
W wire
WA analog signal wire
WD digital signal wire
WH wire harness

1. A wiring system, comprising:
a digital signal wire,
wherein the digital signal wire includes an aluminum wire or an aluminum alloy wire.

2. The wiring system according to claim 1, wherein the digital signal wire includes an aluminum wire or an aluminum alloy wire, the aluminum wire or aluminum alloy wire having a resistance per unit length of 210 mΩ/m or less.

3. The wiring system according to claim 1, wherein the digital signal wire includes an aluminum wire or an aluminum alloy wire, the aluminum wire or aluminum alloy wire having a resistance per unit length of 110 mΩ/m or greater.

4. The wiring system according to claim 1, comprising:
a plurality of the digital signal wires, and
wherein each digital signal wire of the plurality of the digital signal wires is an aluminum wire or an aluminum alloy wire.

5. The wiring system according to claim 4, wherein each digital signal wire of the plurality of the digital signal wires is an aluminum wire or an aluminum alloy wire, the aluminum wire or aluminum alloy wire having a resistance per unit length of 210 mΩ/m or less.

6. The wiring system according to claim 4, wherein each digital signal wire of the plurality of the digital signal wires is an aluminum wire or an aluminum alloy wire, the aluminum wire or aluminum alloy wire having a resistance per unit length of 110 mΩ/m or greater.

7. The wiring system according to claim 1, wherein the aluminum wire or the aluminum alloy wire has a conductor cross-sectional area of 0.35 mm².

8. The wiring system according to claim 1, wherein
the wiring system includes an analog signal wire, and
the analog signal wire includes a copper wire or a copper alloy wire.
